(19) United States
(12) Patent Application Publication
(10) Pub. No.: US 2011/0265187 A1
(43) Pub. Date: Oct. 27, 2011

(54) System and method for user selectable privacy protections on portable communication devices

(76) Inventor: De Xiong Li, Sunnyvale, CA (US)

(21) Appl. No.: 13/066,830

(22) Filed: Apr. 25, 2011

Related U.S. Application Data
(60) Provisional application No. 61/327,107, filed on Apr. 23, 2010.

(51) Int. Cl. G06F 21/24

(52) U.S. Cl. 726/27

(57) ABSTRACT

This invention discloses an apparatus for running an application in a network-based communication system. The apparatus comprising a processing element comprising a processor coupled to a memory. The processing element further provides a user interface to execute a privacy protection application permits the user to enter a plurality of privacy data to selectively disclose the privacy data for running another application executable from the apparatus.

This Non-Provisional Application is based on and claims the Priority of previously filed co-pending Provisional Applications 61/327,107 filed on Apr. 23, 2010. The disclosures made in Applications 61/327,107 are hereby incorporated by reference.

### BACKGROUND OF THE INVENTION

1. Field of the Invention

This invention relates generally to systems and methods of privacy protections of applications on the network-based communication systems. More particularly, this invention relates to the systems and methods of techniques for providing user selected privacy protection when invoking an application in the network-based communication systems.

2. Description of the Related Art

Many applications today that utilize the Internet and different kinds of networked-base communication systems require a user to disclose user's private information. The required disclosures often include the location information of the users or the devices. However, disclosures of such information without appropriate measures of privacy protection may present heightened privacy and safety threats.

Currently there are only very limited techniques available that can effectively prevent one from being identified and located should one's detailed movement be continuously tracked. This lack of protection has impose significant hindrance and concerns to the development and deployment of a wide range of important applications like location-based services. There is an urgent need, therefore, to develop techniques that would allow users or devices to select and limit the disclosures of their private information including the location information. Specifically, current surges of many social network applications in the network-based communication systems further require users to disclose additional private information such as gender, age, hobbies, range salary, religious belief, etc., online. However, such disclosures without appropriate user options to select and protect their privacy present even greater threats to fraud and safety to those online users.

Therefore, a need still exists in the field of web-based network communications and mobile communication devices to provide new and improved system configuration and methods to overcome such limitations.

### SUMMARY OF THE PRESENT INVENTION

It is therefore an aspect of the present invention to provide new and improved system configuration and methods to for a user to select different level of disclosures of the private information in the networked-based communication systems such that the above-discussed difficulties and concerns can be resolved.

Another aspect of the present invention is to provide new and improved system configuration and methods for running applications in the networked-based communication systems by providing a process to simplify the selection of the entry of different levels of private information on the mobile device users. The present invention provides a simplified and convenient process for a user to easily build a private data-space of different privacy protection levels for different types of applications. The present invention can therefore substantially eliminate repeated efforts necessary for entering required private data with appropriate protections by simply selecting appropriate privacy protection levels.

Another aspect of the present invention is to provide new and improved system configuration and methods to for running applications in the networked-based communication systems by providing a process to simplify the selection of the entry of different levels of private information that disclose only the minimum amount of data required for each of the specific applications on the mobile device users.

Another aspect of the present invention is to provide new and improved system configuration and methods to for running applications in the networked-based communication systems by providing a process to simplify the selection of the entry of different levels of private information that disclose only the results of calculation, without disclosures of the data used in the application, as that required for the applications on the mobile device users.

Briefly, in an embodiment, the present invention discloses an apparatus for running an application in a network-based communication system. The apparatus comprising a processing element comprising a processor coupled to a memory. The processing element further provides a user interface to execute a privacy protection application permits the user to enter a plurality of privacy data to selectively disclose the privacy data for running another application executable from the apparatus. In another embodiment, the privacy protection application constituting a second application called by another application executable from the apparatus as a first application to retrieve and utilize the privacy data selected by the user to run the another application. In another embodiment, the privacy protection application constituting a second application called by the another application executable from the apparatus as a first application and to automatically detect a minimum amount of the privacy data to retrieve and utilize the minimum amount of privacy data selected by the user to run the another application. In another embodiment, the privacy protection application permitting the user to enter a range to selectively disclose the privacy data including ranges of latitude and longitude of a user's geographic location for running another application executable from the apparatus. In another embodiment, the privacy protection application permitting the user to enter a range to selectively disclose the privacy data including a distance from a user's geographic location for running another application executable from the apparatus. In another embodiment, the privacy protection application permitting the user to enter a relative distance option to selectively disclose the privacy data including a relative distance between a user's geographic location and another device for running another application executable from the apparatus. In another embodiment, the privacy protection application permitting the user to enter a range to selectively disclose the privacy data including a user's age for running another application executable from the apparatus. In another embodiment, the privacy protection application permitting the user to enter a yes-or-no option to selectively disclose the privacy data including a yes-or-no answer for running another application executable from the apparatus.

The present invention further discloses a mobile communication device operated with an operating system (OS) to control and manage a plurality of application processes. The mobile communication device further includes a privacy protection application process, called by at least one of the application processes to allow a user of the mobile communication device to selectively enter privacy data to execute at least one of the plurality of application processes from the mobile communication device. In another embodiment, the privacy protection application process is called by at least one of the application processes by an inter-application communication scheme to allow a user of the mobile communication device to enter the privacy data to carry out the application calls the privacy protection application.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIG. 1 is a system functional diagram for showing a network-based communication system configured in accordance with an illustrative embodiment of the invention.

FIG. 2 is system diagram for showing data transmission and processes among the network-based communication system to carry out the user enquiry and retrieval among a mobile device and/ or servers of the present invention.

FIG. 3 is a flowchart to illustrate the processing steps carried among the mobile devices and the operating system of a base station or a server to enable the “5W1H” search according to user defined scope of this invention.

FIGS. 4 and 5 are respectively the screen displays of the Privacy Protection Application of this invention and another Application (APP-1) that calls the Privacy Protection Application (APP-2) of this invention.

### DETAILED DESCRIPTION OF THE PREFERRED EMBODIMENT

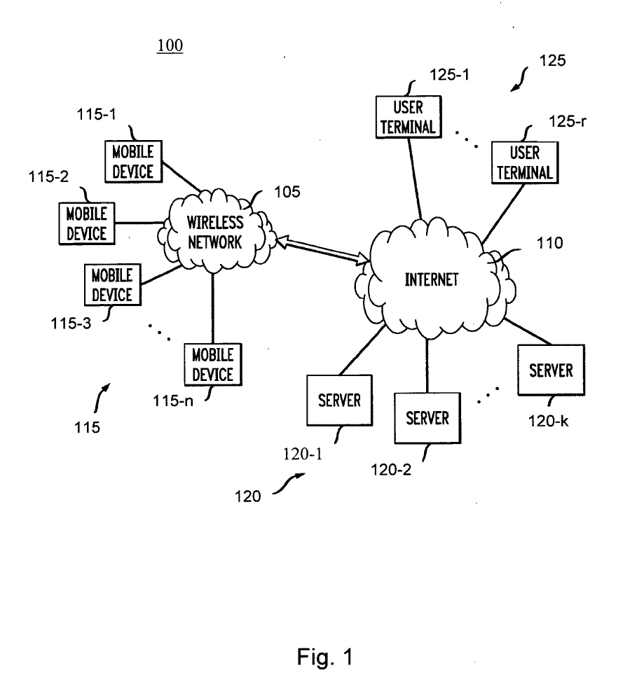

FIG. 1 is a system functional diagram for showing a network-based communication system 100 configured in accordance with an illustrative embodiment of this invention. The system 100 includes a wireless network 105 coupled to the Internet 110, a set of mobile devices 115, a set of servers 120 and a set of user terminals 125. As shown in FIG. 1, the numbers n, k, and r are adjustable integer numbers to denote the n mobile devices 115-1, . . . 115-n are coupled to the wireless network 105, k servers 120-1, . . . 120-k and r user terminals 120-1, . . . 120-r are coupled to the Internet 110. Also, alternative embodiments of the invention may not include the particular system elements shown, and may include other elements of a type and configuration known to those skilled in the art, in place of or in addition to the particular elements shown. The mobile devices 115 and user terminals 125 may be more generally referred to herein as user devices. The term “user” is intended to include, without limitation, an individual, a group of individuals, a business, an organization, or any other entity capable of deriving benefit from use of at least a portion of the system 100. Actions described herein as being performed by or otherwise associated with a user may be performed by or otherwise associated with an individual or other entity, a corresponding device, or both the entity and the device. The network configuration of system 100 is shown only as an example. The present invention is not limited by the configuration as shown. The Internet as shown may include an intranet, an extranet, a wide area network (WAN), a metropolitan area network (MAN), a wired local area network (LAN), an IEEE 802.11 or Wi-Fi wireless LAN, a satellite communications network, a virtual private network (VPN), a public switched telephone network (PSTN), a cellular network based on third generation (3G) wideband code division multiple access (CDMA) or other standard, as well as portions or combinations of these and other networks.

The mobile devices 115 may collectively comprise a wide variety of different devices configurable for communication over the network 12. The term “mobile device” as used herein is intended to include, without limitation, any type of portable information processing device capable of being configured for communication over a network. Examples of mobile devices 115 utilizable in FIG. 1 include a mobile telephone, a personal digital assistant (PDA), a palmtop computer, a hand-held computer, a laptop computer, a tablet computer, a global positioning system (GPS) receiver or other GPS-based navigational device, an MP3 player or other type of audio player, a pager, a watch or other timepiece, a camera, a portable game player, etc. The servers 120 may comprise, by way of example, network computers or other types of computers or processing elements capable of being configured for the maintenance, storage, delivery or other processing of information received or deliverable over the Internet or other type of network. Furthermore, one or more of the user terminals 120 may each comprise a mobile device. Also, a given one of the user terminals 120 may comprise a non-mobile device, including, by way of example, a desktop personal computer, a workstation, a minicomputer, a mainframe computer, a television, a set-top box, a kiosk, etc.

As commonly understood that each of these mobile devices, servers, user terminals, can function as an independent data processing element and each of these data processing elements may include s process, a memory for data storage and a network or communication interface to connect to a network based communication system either through physical connections or through wireless interconnections.

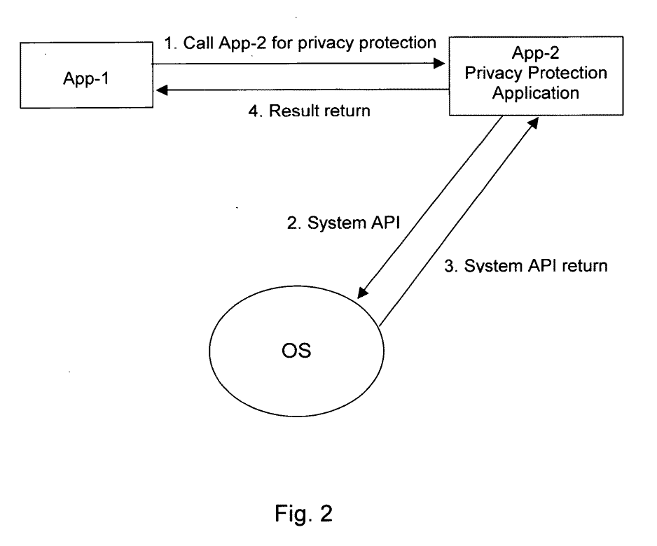

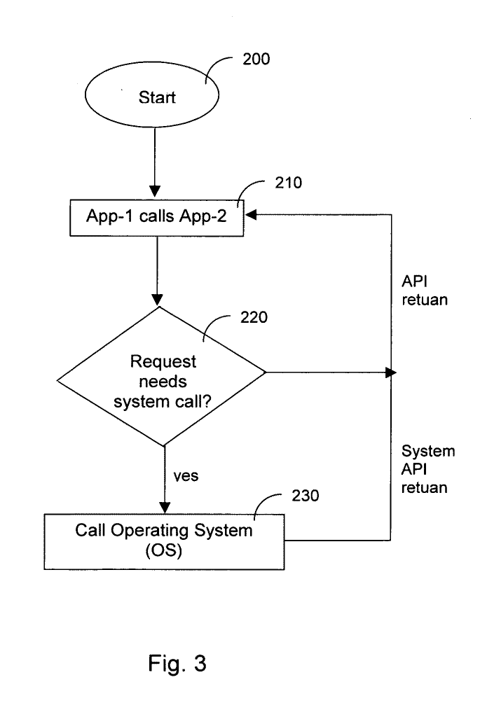

FIG. 2 is a system functional diagram and FIG. 3 is a flowchart to illustrate the processes performed in a mobile device by applying an inter-application communication scheme to build a user selected privacy protection application of this invention. It is understood that such processes may be carried among a user and a server or a user terminal as well as that shown in FIG. 1. The inter-application communication process starts with a user starts an application (APP-1) from a mobile device (Step 200). The APP-1 then calls a Private Protection Application (APP-2) of this invention to allow a user of the mobile device to enter and define privacy protection parameters. Then, the APP-2 receives the user entry. The user entry may be in a form such as:

PRIVACY://distance&range_of_age&type_mobile_device/From=APP-1.

The Privacy Protection Application then processes the user entries to determine if an inter-application system call is necessary depending on the scopes of privacy protection requested by the user (Step 220). If it is determined that a system call is not necessary, then an API return is provided to the APP-1. If the system call is necessary, then an inter-application communication call is made to the operation system (OS) of the mobile device, or a server depending on the scopes of the user request (Step 230). The processes are completed by retrieving a system API return from the OS back to the user through APP-1 as the “result return” as that requested by the user.

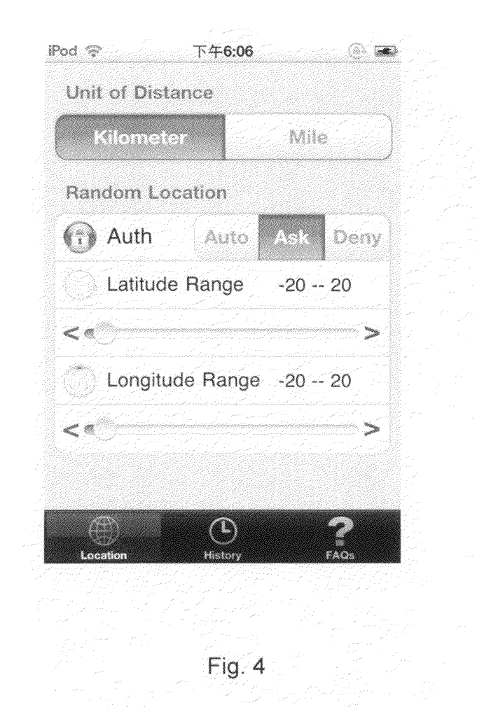

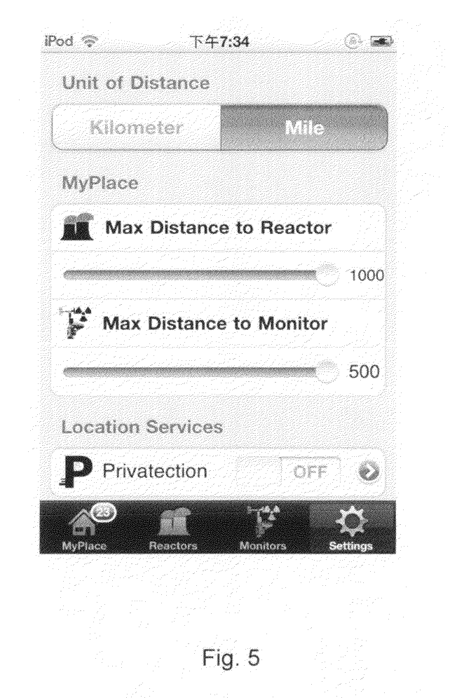

The Privacy Protection Application provides the user an option to select different options to protect private information of a user. As a selected option, the user may disable the geographic location feature of every application by providing a “location zoning” data such as a radius of five miles from a predefined landmark to satisfy a geographic location data requirement of an application as that shown in FIGS. 4 and 5. The exact location of a user is therefore not disclosed. The present invention further includes an option by storing all devices geographic location in a central data center. Specific applications that require geographic locations may be satisfied by calculating and providing relative distances between different mobile devices instead of providing exact locations of different devices. The Application of this invention may also provide an option by implementing a function of get_distant_from(pl):. The function then returns the distant between location pi and current location. The application will have the distant value but real geo-location of the user is not disclosed and user's privacy is protected. Further options of the APP-2 of this invention may implement a “is_in_scope (x1,x2,y1,y2)” process. The function returns a Yes or No determination whether the current location is inside the given scope. Furthermore, the user can define the minimum scope for each application. The minimum scope of the application may be satisfied to utilize the application while the exact geographic location is not disclosed to protect user' privacy. The APP-2 as shown in FIG. 2 can therefore provide flexibilities to allow a user to run different Applications on mobile devices that require a user to disclose certain types of information without disclosing information that may constitute a threat to user's privacy or safety.

The APP-2 as shown in FIG. 2 may also include privacy protection functions for preventing disclosures of gender, birth day or age, salary, height of locations or other information related to user's privacy. The APP-2 as shown in FIGS. 2 and 3 supports the Inter-App communications. The Application of this invention requires a calling time limit to avoid the caller calculation of the real location information. The Application of this invention further supports support history data and related functions, such as the have-Been-Place (latitude, longitude, 20) will return if the location history data includes a place nearby the given location 20 mile or less. This feature will just leak on location to caller rather than the whole history data. For example, to play matching games on mobile devices, two players can match by the privacy protection Application of this invention or alternately protected by a privacy protection center instead of the calling Application, i.e., APP-1.

Therefore, the privacy protection Application of this invention keeps all the private data in a local device such as a mobile phone instead of a cloud based sites. A local device protection of this invention may be setup as a dedicated application of an Application called by inter-application communication rather than built in as part of the operation system (OS). The networking feature should be disabled for this application or app (if the OS provide this control), to prevent transmission of private data from the mobile device. The Privacy Protection Application of this invention further provide options for a user to select disclosures of minimum amount of private data depending on the requirement of each Application.

The scopes of the privacy protection can be conveniently defined without requiring changes made to the operating systems of a mobile device or a server or any data processing element. The inter-application communication scheme can be applied to link different levels of application to conveniently and flexibly link and activate different applications to process and retrieve required data and content needed for different levels of “Applications” implemented in a mobile device or any of the data processing elements as shown in FIG. 1.

Specifically, the Privacy Protection application, APP-2 of this invention enables a user to enter different levels of privacy protection when running multiple applications that may require disclosures of private data. The user may enter a privacy protection level to allow disclosures of different combinations of private information and therefore, the processes provide convenient and flexible applications for a mobile device user such that the typing and data entry requirements are greatly reduced. A user may also execute the Privacy Protection Application of this invention automatically by providing minimum amount of private information depending on the requirements of different applications thus greatly enhance the convenience and safety of a user's privacy without requiring significant efforts from a mobile device user.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention. Those approaches and mechanisms in the art will appreciate variations of the above-described embodiments that fall within the scope of the invention. As a result, the invention is not limited to the specific examples and illustrations discussed above, but only the following claims and their equivalents.

I claim:

1. An apparatus for use in managing information content in a network-based communication system, the apparatus comprising:
a processing element comprising a processor coupled to a memory;
the processing element further provides a user interface to execute a privacy protection application permitting the user to enter a plurality of privacy data to selectively disclose the privacy data for running another application executable from the apparatus.

2. The apparatus of claim 1 wherein:
the privacy protection application constituting a second application called by the another application executable from the apparatus as a first application to retrieve and utilize the privacy data selected by the user to run the another application.

3. The apparatus of claim 1 wherein:
the privacy protection application constituting a second application called by the another application executable from the apparatus as a first application and to automatically detect a minimum amount of the privacy data to retrieve and utilize the minimum amount of privacy data selected by the user to run the another application.

4. The apparatus of claim 1 wherein:
the privacy protection application permitting the user to enter a range to selectively disclose the privacy data including ranges of latitude and longitude of a user's geographic location for running another application executable from the apparatus.

5. The apparatus of claim 1 wherein:
the privacy protection application permitting the user to enter a range to selectively disclose the privacy data including a distance from a user's geographic location for running another application executable from the apparatus.

6. The apparatus of claim 1 wherein:
the privacy protection application permitting the user to enter a relative distance option to selectively disclose the privacy data including a relative distance between a user's geographic location and another device for running another application executable from the apparatus.

7. The apparatus of claim 1 wherein:
the privacy protection application permitting the user to enter a range to selectively disclose the privacy data including a user's age for running another application executable from the apparatus.

8. The apparatus of claim 1 wherein:
the privacy protection application permitting the user to enter a yes-or-no option to selectively disclose the privacy data including a yes-or-no answer for running another application executable from the apparatus.

9. A mobile communication device operated with an operating system (OS) to control and manage a plurality of application processes, further comprising:
a privacy protection application process, called by at least one of the application processes to allow a user of the mobile communication device to selectively enter privacy data to execute at least one of the plurality of application processes from the mobile communication device.

10. The mobile communication device of claim 9 wherein:
the privacy protection application process is called by at least one of the application processes by an inter-application communication scheme to allow a user of the mobile communication device to enter the privacy data to carry out the application calls the privacy protection application.
